(19) United States
(12) Patent Application Publication
(10) Pub. No.: US 2023/0122641 A1
(43) Pub. Date: Apr. 20, 2023

(54) SECURITY CAMERA WITH PAN TILT AND OMNIDIRECTIONAL MONITORING METHOD FIELD

(71) Applicant: ZHANRUI ZHANG, Shenzhen (CN)

(72) Inventor: ZHANRUI ZHANG, Shenzhen (CN)

(21) Appl. No.: 18/082,591

(22) Filed: Dec. 16, 2022

(30) Foreign Application Priority Data
Jul. 18, 2022 (CN) 202210843503.X

(51) Int. Cl. G03B 17/56

(52) U.S. Cl. CPC G03B 17/561

(57) ABSTRACT

The present disclosure provides a camera and an omnidirectional monitoring method of the camera, the camera includes a camera body, including an upper housing and a monitoring member connected with the upper housing; a rotating assembly, received in the camera body, the rotating assembly is configured to drive the camera body to rotate vertically, and/or the rotating assembly is configured to drive the camera body to rotate horizontally; and a plurality of pyroelectric infrared sensor (PIR) probes, disposed on the upper housing or the monitoring member. The camera can monitor the outside omnidirectionally.

The present disclosure relates to the technical field of cameras, specifically to a low power consumption camera, and an omnidirectional monitoring method of the low power consumption camera.

### BACKGROUND

At present, with the popularization of solar cells and the maturity of low-power cameras, WIFI or 4G low-power consumption cameras are more and more. The working principle of the camera includes: the camera is usually on standby to reduce power consumption, pyroelectric infrared sensor (PIR) or radar is used to detect active objects human bodies, or animals, etc. Its detection component may be PIRs or a combination of PIRs and radar located around a periphery of lens, which causes that the camera can only monitor certain areas, and the detection range is limited. Therefore, it is necessary to optimize the design of the camera.

### SUMMARY

The object of the present disclosure is to provide a low power consumption camera and an omnidirectional monitoring method, aiming to solve the problem existing in the background.

To achieve the object, the present disclosure provides a low power consumption camera, including: a camera body, including an upper housing and a monitoring member connected with the upper housing; a rotating assembly, received in the camera body, the rotating assembly is configured to drive the camera body to rotate vertically, and/or the rotating assembly is configured to drive the camera body to rotate horizontally; and a plurality of pyroelectric infrared sensor (PIR) probes, disposed on the upper housing or the monitoring member.

Furthermore, the monitoring member is arranged on a lower end of the upper housing.

Furthermore, the PIR probes are arranged at interval along a circumference of the upper housing.

Furthermore, the PIR probes are arranged at interval along a circumference of the monitoring member.

Furthermore, the PIR probes are arranged at interval along a circumference of the housing and a circumference of the monitoring member.

Furthermore, the camera further includes a solar panel, connected to the upper housing.

Furthermore, the upper housing is connected to a lower end of the solar panel.

Furthermore, the camera further includes at least one antenna, configured to communicate with a wireless network, the antenna is arranged on the camera body.

Furthermore, the antenna is arranged on a top of the upper housing.

Furthermore, the camera further includes a main board, arranged in the camera body and electronically connected with the rotating assembly; and a microprogrammed control unit (MCU), arranged in the camera body, the low power consumption MCU is electrically connected with the main board and the PIR probes.

Furthermore, the MCU is configured to acquire a time for the camera body to rotate one circle, and calibrate a rotation speed of the camera body according to the time for the camera body to rotate one circle and a preset time for the camera body to rotate one circle.

Furthermore,the camera further includes a detection device, the detection device includes: at least one hall sensor, arranged on the upper housing and electronically connected with the main board, the hall sensor is arranged horizontally, and a position of the hall sensor is corresponded with that of the PIR probe; and at least one magnet, arranged on the monitoring member, when the camera body rotates and the hall sensor is close to the magnet, the hall sensor generates a signal which is configured to detect a rotating angle of the monitoring member.

Furthermore, the camera further includes a detection device, the detection device includes: at least one switch, arranged on the upper housing and electronically connected with the main board, the switch is arranged horizontally, and a position of the switch is corresponded with that of the PIR probe; and at least one protrusion, arranged on the monitoring member, when the camera body rotates and the switch is contacted with to the protrusion, the switch generates a signal which is configured to detect a rotating angle of the monitoring member.

Furthermore, the rotating assembly includes: a first rotating motor, arranged in the upper housing and configured to drive the camera body to rotate horizontally; and a second rotating motor, arranged in the monitoring member and configured to drive the camera body to rotate vertically.

The present disclosure further provides an omnidirectional monitoring method of a camera, the camera includes a camera body, a rotating assembly received in the camera body, a plurality of PIR probes disposed on the upper housing or the monitoring member, and a MCU arranged in the camera body and electronically connected with the rotating assembly, the rotating assembly is configured to drive the camera body to rotate vertically, and/or the rotating assembly is configured to drive the camera body to rotate horizontally, wherein the method includes:
S1: enabling the camera body to turn a circle when turning on, and acquiring a time for turning one circle;
S2: detecting intrusion information by the PIR probes from outside, and transmitting the intrusion information to the MCU, sending a driving signal by the MCU to enable the camera body to shoot;
S3: determining an intrusion area corresponding to the intrusion information by the MCU according to the intrusion information detected by the PIR probe, controlling the camera body to rotate towards the intrusion area by enabling the rotating assembly to work for a certain time, and controlling the camera body to shoot the intrusion area; and
S4: detecting intrusion information continuously by the PIR probes, so the camera body acquires the intrusion information in real time to monitor the outside omnidirectionally.

The beneficial effects of the present disclosure include: three to four PIR probes are placed at a certain angle on an upper part or a bottom part of the camera body, or PIR probes and a radar component are placed at a certain angle on an upper part or a bottom part of the camera body, so as to omnidirectionally detect anomaly intrusion information. By calculating a start time and a signal intensity of each PIR probe, an approximate orientation of the intrusion object is calculated, and then the camera is driven to face towards the intrusion object and starts shooting, and false alarms are avoided.

### BRIEF DESCRIPTION OF THE DRAWINGS

Implementations of the present disclosure will now be described, by way of embodiment, with reference to the attached FIG.s. It should be understood, the drawings are shown for illustrative purpose only, for ordinary person skilled in the art, other drawings obtained from these drawings without paying creative labor by an ordinary person skilled in the art should be within scope of the present disclosure.

FIG. 1is a structure diagram of a camera according to an embodiment of the present disclosure.

FIG. 2 is a structure diagram of a camera according to another embodiment of the present disclosure.

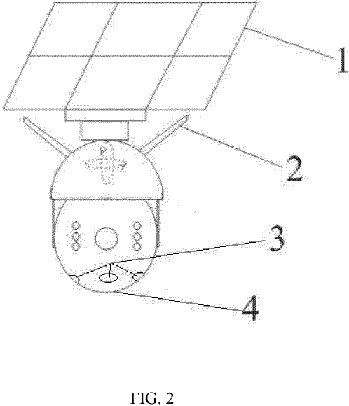

FIG. 3 is a schematic diagram of a monitoring area of the FIR probe according to an embodiment of the present disclosure.

FIG. 4 is a schematic diagram of a working principle of the camera according to an embodiment of the present disclosure.

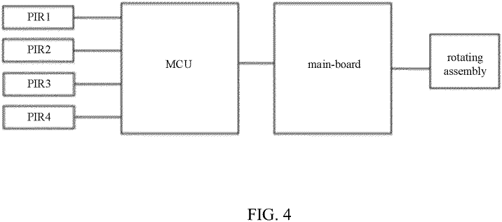

FIG. 5 is a bottom view of the camera camera of FIG. 1.

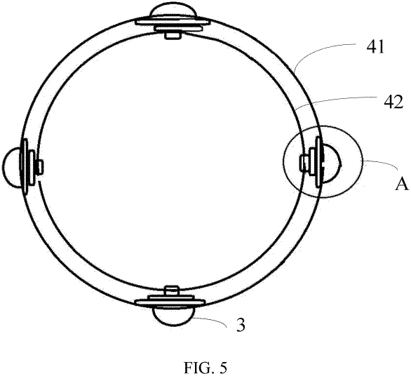

FIG. 6 is an enlarged view of portion A as shown in FIG. 5.

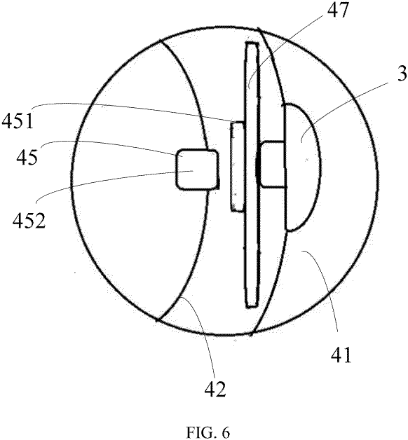

FIG. 7 is an structure diagram of a detection device according to another embodiment.

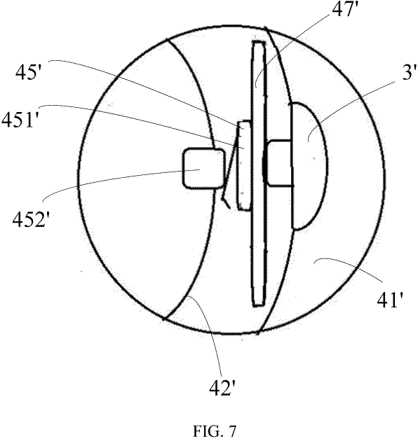

FIG. 8 is a cross section view of a part of the camera body of FIG. 1.

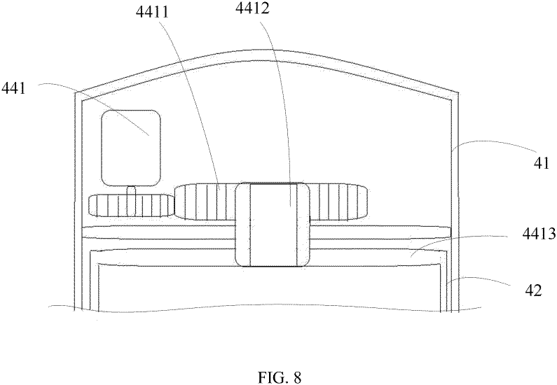

FIG. 9 is a flow chart of an omnidirectional monitoring method of the camera according to an embodiment of the present disclosure.

FIG. 10 is a flow chart of another omnidirectional monitoring method of the camera according to an embodiment of the present disclosure.

Labels illustration for drawings:

1, solar panel; 2, antenna; 3, 3′ PIR probes; 4, camera body; 41, 41′, upper housing; 42, 42′, monitoring member; 43, MCU; 44, rotating assembly; 441, first rotating motor; 4411, gear; 4412, rotating shat; 4413, bracket; 442, second rotating motor; 45, detection device; 451, hall sensor; 452, magnet; 45′, detection device; 451′, switch; 452′, protrusion; 47, 47′, main board.

The realization of the aim, functional characteristics, advantages of the present disclosure are further described specifically with reference to the accompanying drawings and embodiments.

### DETAILED DESCRIPTION

It will be appreciated that for simplicity and clarity of illustration, where appropriate, reference numerals have been repeated among the different FIG.s to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion in the so-described combination, group, series, and the like. the present disclosure is illustrated by way of example and not by way of limitation in the FIG.s of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

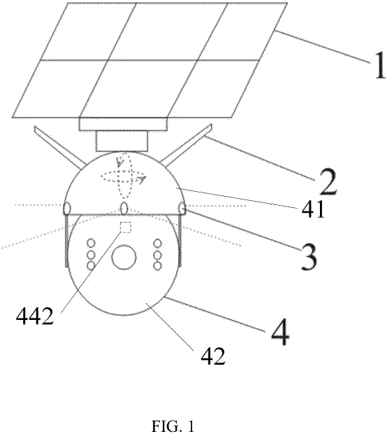

As shown in FIGS. 1~8, the present disclosure provides a low power consumption camera according to an embodiment, which includes a solar panel 1 and a camera body 4 connected with a lower end of the solar panel 1, the camera body 4 includes an upper housing 41 and a monitoring member 42, three or fourth PIR probes 3 are evenly arranged around the upper housing, a detection angle of the PIR probe 3 is 100~120°. The top of the camera body 4 is also provided with a plurality of antennas 2, the antenna 2 is used to communicate with a wireless network. The solar panel 1 is connected with the upper housing 41 at an angle.

In the embodiment, the camera body 4 is also internally provided with a low power consumption microprogrammed control unit (MCU) 43, the low power consumption MCU 43 is mounted on a main board 47, the PIR probe 3 is electrically connected to the low-power MCU 43, the main-boar d is also connected to a rotating assembly 44, the rotating assembly 44 is used to drive the camera body 4 to rotate in a horizontal direction or a vertical direction. In detail, the MCU 43 may include lens and digital signal processor, etc. The rotating assembly 44 may include a first rotating motor 441 arranged in the upper housing 41, and a second rotating motor 442 arranged in the monitoring member 42, the first rotating motor 441 is used to drive the camera body 4 to rotate horizontally, and the second rotating motor 442 is used to drive the camera body 4 to rotate vertically. The upper housing 41 is internally provided with the a bracket 4413 which is configured to mount the first rotating motor 441, the first rotating motor 441 can derive a gear 4411 to rotate, the gear 4411 is arranged horizontally, a rotating shat 4412 is connected with the gear 4411 and an outer housing of the monitoring member 42. So, the gear 4411 can drive the monitoring member 42 to rotate horizontally by the gear 4411. The second rotating motor 442 may be similar to the first rotating motor 441.

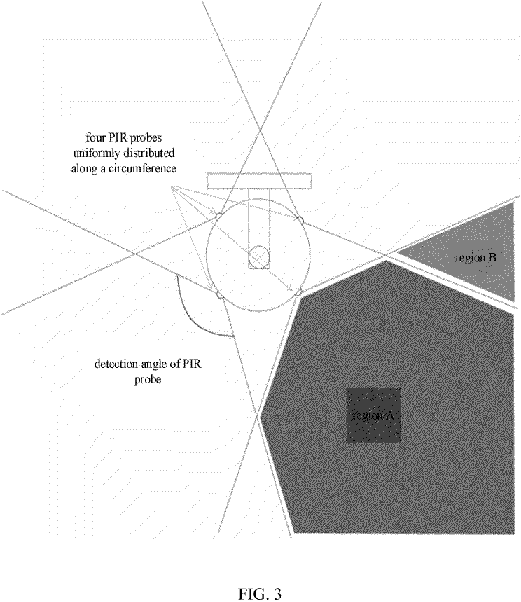

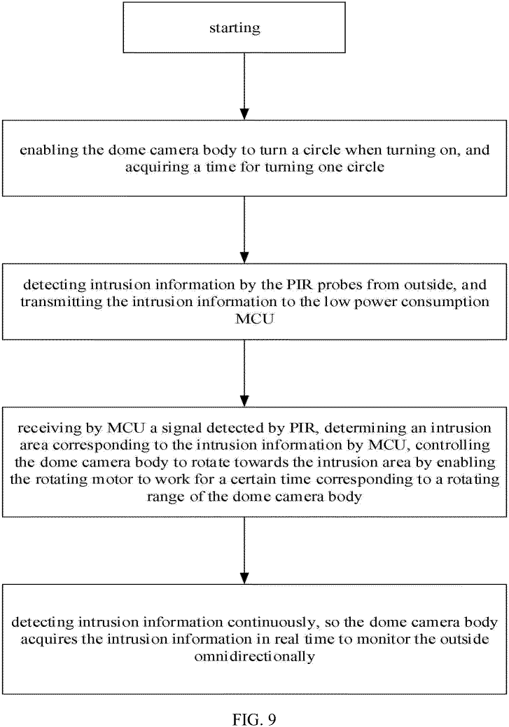

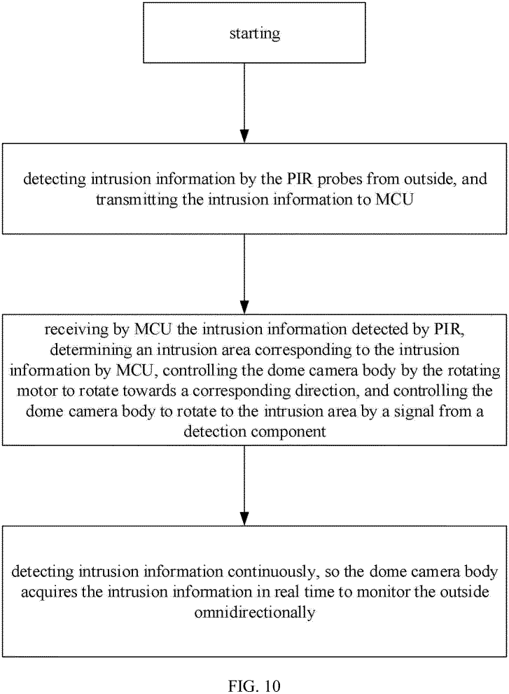

As shown in FIGS. 9-10, an omnidirectional monitoring method of the low power consumption camera, which includes the following steps:
S1: enabling the camera body to turn one circle when turning on, and acquiring a time for turning one circle;
S2: detecting intrusion information by the PIR probes 3 from outside, and transmitting the intrusion information to the low power consumption MCU 43, sending a driving signal by the low power consumption MCU 43 to enable the camera body 4 to shoot;
S3: determining an intrusion area corresponding to the intrusion information by the low power consumption MCU 43 according to the intrusion information detected by the PIR probe, controlling the camera body to rotate towards the intrusion area by enabling the rotating motor to work for a certain time which is corresponding to a rotating range of the camera body, and controlling the camera body to shoot the intrusion area;
S4: detecting intrusion information continuously by the PIR probes 3. Specifically, the detection angle of PIR probe 3 can be seen from FIG. 3, the region A presents an area detected by one single PIR probe, the region B presents an area detected by two PIR probes at the same time. The intrusion signals obtained in different areas can be processed by the low power consumption MCU 43, so the low power consumption MCU 43 can control the working time of the rotating motor. So that the camera body 4 can acquire signals of the target image in real-time to achieve the purpose of all-round detection.

In the embodiment, after the camera body 4 continuously works for a certain time, the calibration mode is started. That is, the camera body 4 is controlled to turn one circle, and the time of the camera body 4 turning one circle is calibrated according to the time in S1, so the low power consumption MCU 43 can sent the driving signal to control the accuracy of the working time of the rotating motor, and to accurately position the camera body 4. Furthermore, Furthermore, the MCU is configured to acquire a time for the camera body to rotate one circle, and calibrate a rotation speed of the camera body according to the time for the camera body to rotate one circle and a preset time for the camera body to rotate one circle.

In the present embodiment, the upper housing may be placed with at least one detection device 45 in the horizontal direction, the position of the detection devices 45 is corresponding to that of the PIR probe 3. The detection device 45 includes a hall sensor 451. Preferably, there are a plurality of detection devices 45 which can be evenly arranged, so that the camera can be quickly positioned without calibration. It should be understood that, the camera includes the main board 47 which can be a printed circuit board electrically connected with the detection devices 45. The monitoring member 42 is provided with at least one magnet 452 matched with the detection device 45. When the magnet 452 is close to the hall sensor 451 of the detection device 45, the hall sensor 451 generates a signal which may be used to detect a rotating angle of the monitoring member 42. So, MCU 43 can control the monitoring member 42 to rotate to an accurate position by the rotating motor 4.

In another embodiment, the upper housing may be placed with at least one detection device 45′ in the horizontal direction, the position of the detection devices 45′ is corresponding to that of the PIR probe 3′. The detection device 45′ may include a switch 451′ arranged in the upper housing 41′, and a protrusion 452′ arranged on the monitoring member 42′. Preferably, there are a plurality of detection devices 45′ which can be evenly arranged, so that the camera can be quickly positioned without calibration. It should be understood that, the camera includes the main board 47′ which can be a printed circuit board electrically connected with the detection devices 45′. When the switch 451′ is contacted with the protrusion 452′, the switch 451′ of the detection device 45′ generates a signal which may be used to detect a rotating angle of the monitoring member 42′. So, MCU can control the monitoring member 42′ to rotate to an accurate position by the rotating motor.

Three to four PIR probes are placed at a certain angle on an upper part or a bottom part of the camera body, or PIR probes and a radar component are placed at a certain angle on an upper part or a bottom part of the camera body, so as to omnidirectionally detect anomaly intrusion information. By calculating a start time and an intensity of each PIR probe, an approximate orientation of the intrusion object is calculated, and then the camera is driven to face the intrusion object and starts shooting, and false alarms are avoided.

The above description is merely some embodiments. It should be noted that for one with ordinary skills in the art, improvements can be made without departing from the concept of the present disclosure, but these improvements shall fall into the protection scope of the present disclosure.

What is claimed is:

1. A camera, comprising:
a camera body, comprising an upper housing and a monitoring member connected with the upper housing;
a rotating assembly, received in the camera body, the rotating assembly is configured to drive the camera body to rotate vertically, and/or the rotating assembly is configured to drive the camera body to rotate horizontally; and
a plurality of pyroelectric infrared sensor (PIR) probes, disposed on the upper housing or the monitoring member.

2. The camera according to claim 1, wherein the monitoring member is arranged on a lower end of the upper housing.

3. The camera according to claim 1, wherein the PIR probes are arranged at interval along a circumference of the upper housing.

4. The camera according to claim 1, wherein the PIR probes are arranged at interval along a circumference of the monitoring member.

5. The camera according to claim 1, wherein the PIR probes are arranged at interval along a circumference of the housing and a circumference of the monitoring member.

6. The low power consumption camera according to claim 1, further comprising:
a solar panel, connected to the upper housing.

7. The camera according to claim 6, wherein the upper housing is connected to a lower end of the solar panel.

8. The camera according to claim 1, further comprising:
at least one antenna, configured to communicate with a wireless network, the antenna is arranged on the camera body.

9. The camera according to claim 8, wherein the antenna is arranged on a top of the upper housing.

10. The camera according to claim 8, further comprising:
a main board, arranged in the camera body and electronically connected with the rotating assembly;
a microprogrammed control unit (MCU), arranged in the camera body, the MCU is electrically connected with the main board and the PIR probes.

11. The camera according to claim 10, wherein the MCU is configured to acquire a time for the camera body to rotate one circle, and calibrate a rotation speed of the camera body according to the time for the camera body to rotate one circle and a preset time for the camera body to rotate one circle.

12. The camera according to claim 10, wherein the camera further comprises a detection device, the detection device comprises:
at least one hall sensor, arranged on the upper housing and electronically connected with the main board, the hall sensor is arranged horizontally, and a position of the hall sensor is corresponded with that of the PIR probe; and
at least one magnet, arranged on the monitoring member, when the camera body rotates and the hall sensor is close to the magnet, the hall sensor generates a signal which is configured to detect a rotating angle of the monitoring member.

13. The camera according to claim 10, wherein the camera further comprises a detection device, the detection device comprises:
at least one switch, arranged on the upper housing and electronically connected with the main board, the switch is arranged horizontally, and a position of the switch is corresponded with that of the PIR probe; and
at least one protrusion, arranged on the monitoring member, when the camera body rotates and the switch is contacted with to the protrusion, the switch generates a signal which is configured to detect a rotating angle of the monitoring member.

14. The camera according to claim 1, wherein the rotating assembly comprises:
a first rotating motor, arranged in the upper housing and configured to drive the camera body to rotate horizontally; and
a second rotating motor, arranged in the monitoring member and configured to drive the camera body to rotate vertically.

15. An omnidirectional monitoring method of a camera, the camera comprises a camera body, a rotating assembly received in the camera body, a plurality of PIR probes disposed on the upper housing or the monitoring member, and a MCU arranged in the camera body and electronically connected with the rotating assembly, the rotating assembly is configured to drive the camera body to rotate vertically, and/or the rotating assembly is configured to drive the camera body to rotate horizontally, wherein the method comprises:
S1: enabling the camera body to turn a circle when turning on, and acquiring a time for turning one circle;
S2: detecting intrusion information by the PIR probes from outside, and transmitting the intrusion information to the MCU, sending a driving signal by the MCU to enable the camera body to shoot;
S3: determining an intrusion area corresponding to the intrusion information by the MCU according to the intrusion information detected by the PIR probe, controlling the camera body to rotate towards the intrusion area by enabling the rotating assembly to work for a certain time, and controlling the camera body to shoot the intrusion area; and
S4: detecting intrusion information continuously by the PIR probes, so the camera body acquires the intrusion information in real time to monitor the outside omnidirectionally.
